(19) United States
(12) Patent Application Publication
(10) Pub. No.: US 2015/0294539 A1
(43) Pub. Date: Oct. 15, 2015

(54) METHOD FOR REMOTELY CONTROLLING HUMAN PERCEIVABLE OUTPUT OF A PLURALITY OF DEVICES, SYSTEM, TRANSMITTER, DEVICE, SOFTWARE PRODUCT AND HUMAN UNPERCEIVABLE ACOUSTIC SIGNAL FOR PERFORMING THE METHOD

(71) Applicants: JF OCEANS, Kasterlee (BE); PROMOTIE VOOR SPECIALE EVENEMENTEN - BELGIUM, Antwerpen (BE)

(72) Inventors: Alain Van Buyten, Knokke (BE); Philip Van Gasse, Aalst (BE); Jan Vereecke, Schoten (BE); Jan Van Esbroeck, Schilde (BE); Stefan Esselens, Schilde (BE)

(73) Assignees: PROMOTIE VOOR SPECIALE EVENEMENTEN - BELGIUM, Antwerpen (BE); JF OCEANS, Wilrijk (BE)

(21) Appl. No.: 14/440,071

(22) PCT Filed: Oct. 31, 2013
(86) PCT No.: PCT/EP2013/072826

§ 371 Date: Apr. 30, 2015

(30) Foreign Application Priority Data
Oct. 31, 2012 (EP) PCT/EP2012/071639
Mar. 14, 2013 (EP) PCT/EP2013/055301

(51) Int. Cl. G08B 3/10; G10L 21/18

(52) U.S. Cl. CPC G08B 3/10; G10L 21/18

(57) ABSTRACT

Method for remotely controlling human perceivable output of a plurality of devices, wherein the human unperceivable signal sent to the devices for remotely controlling the human perceivable output of the devices is a human unperceivable acoustic signal and wherein the microphones of the input means of the devices are provided to receive the human unperceivable acoustic signal and to transform the human unperceivable acoustic signal to electric signals received by the processor.

The current invention relates to a method for remotely controlling human perceivable output of a plurality of devices, according to the preamble of the first claim.

The present invention also relates to a system, a transmitter, a device, a software product and a human unperceivable acoustic signal for performing the method.

Such methods are already known to the person skilled in the art. WO2012094728A1 for example describes a method for remotely controlling human perceivable output of a plurality of devices, more in particular light outputted by screens of smart mobile phones. The mobile phones comprise input means for receiving signals and transforming them to electric signals, the input means comprising at least a microphone, a processor for receiving the electric signals and output means for outputting human perceivable output in response to electric signals from the processor.

According to the present invention with human perceivable signal is meant any signal that can be sensed in general with the unaided human senses sight, taste, smell, touch and sound. According to the present invention with human unperceivable signal is meant any signal that can't be substantially sensed in general with the unaided human senses sight, taste, smell, touch and sound. Although some people are more perceptive to at least some senses than other people, it is believed that some signals are generally not or only slightly perceivable unaided by humans, which in the context of the current application are called human unperceivable signal.

The method according to WO2012094728A1 further teaches the steps of transmitting such a human unperceivable signal, the input means of the devices receiving the human unperceivable signal, transforming it to corresponding first electric signals and sending the corresponding first electronic signals to the processors of the devices, the processors being programmed such that, in response, the processors send second electronic signals to the output means for correspondingly controlling the human perceivable output of the output means of the devices. WO2012094728A1 for example describes that wi-fi and/or cellular data transfer technology, which is not perceivable by unaided human senses, is used to transmit signals and to use these signals for controlling the light emitted by the screens.

However, such methods using wi-fi and/or cellular data transfer technology often encounter a bottleneck when it comes to the bandwidth available for transmitting the necessary signals to the desired number of devices. As often control of a large number of phones is needed to obtain the desired human perceivable output, for example when creating a so-called audience assisted image composed of the light output of the individual screens of the mobile phones having the desired resolution, the needed bandwidth is relatively large. Such large bandwidths often require special equipment which is often not readily available at venues hosting events where such application would be useful. Moreover, timing of signaling a large number of devices using such transfer technology is not easily controllable, often giving rise to rather uncontrollable delays in receipt of the signal and thus for further complications when substantially synchronized and/or substantially simultaneous output of the phones is desired.

Therefore, it is an object of the current invention to provide a method for remotely controlling human perceivable output of a plurality of devices reducing the required bandwidth.

This is achieved according to the method according to the current invention according to the characterizing part of the first claim.

Thereto, the human unperceivable signal sent to the devices for remotely controlling the human perceivable output of the devices is a human unperceivable acoustic signal and the microphones of the input means of the devices are provided to receive the human unperceivable sound and to transform the human unperceivable sound to the corresponding first electric signals received by the processor.

It has been found that when a human unperceivable acoustic signal is employed, the number of devices receiving the signal has no considerable impact on the acoustic signal and a single acoustic signal can be used for controlling a limited number of devices as well as for controlling the output of a relatively large number of devices.

Moreover, it has been found that generation and transmission of such acoustic signal can be performed using for example transmitter which are often already available at the venues hosting events where such application would be useful.

Moreover, as the transmission speed of sound is relatively homogeneous for the envisioned application, synchronization of the control of the respective devices becomes less complicated.

Although WO2011014292A1 already describes the transmission of human unperceivable signals, in this case ultrasonic signals, and their receipt by microphones of mobile phones, WO2011014292A1 only relates to the detection of the presence of the mobile phone at a certain location associated with the transmitted ultrasonic signal and not with remotely controlling human perceivable output of a plurality of devices.

According to preferred embodiments of the current invention, the human unperceivable acoustic signal is an ultrasonic signal. In the context of the current application, with an ultrasonic acoustic signal is meant an acoustic signal having a frequency which is higher than the frequency of sound which usually can be heard by humans. Ultrasonic signals are preferred because they can often be transmitted with available audio equipment, can often be received with available devices such as for example available mobile phones or even smart mobile phones, tablets, etc. Other human unperceivable acoustic signals can for example be subsonic signals. In the context of the current application, with a subsonic acoustic signal is meant an acoustic signal having a frequency which is lower than the frequency of sound which usually can be heard by humans. Such signal for example has a frequency of below 20 Hz.

According to preferred embodiments of the current invention, the ultrasonic acoustic signal comprises at least one frequency of more than 17 kHz, preferably between 17 kHz and 25 kHz, more preferably between 17 kHz and 20 kHz, most preferably 18 kHz. It has been found that such ultrasonic acoustic signals can often be transmitted using available audio equipment, such as for example available public address systems, can often be received by already available devices such as for example mobile phones, for example smart mobile phones, tablets, etc. Moreover, such acoustic signals have been found to have a speed of sound which resembles the speed of acoustic signals which are audible for most humans such that the latency between emission of audible sound and receipt by humans of audible sound and the latency between emission of the acoustic signal and the reception of the signal by the devices is substantially the same. As a consequence the human perceivable output of the output means of the devices can be substantially synchronized and/or substantially simultaneous with emitted sound, for example through an existing public address system or through an added sound system separate from the public address system and specifically added for transmitting the ultrasonic acoustic signal. This allows, for example, that the human perceivable output of the devices is, for example, outputted by the devices on the rhythm of music which is also transmitted. It has been surprisingly found that the human unperceivable signal most often does not or only minimally interferes with the emitted sound, although exceptions exist depending on, for example, the ambient sound, such as for example the sound of the audience.

It has been found that the signal to noise ratio can be improved by increasing the difference in intensity between the signal and the noise, being for example the noise from the audience and/or even emitted sound, such as for example music.

It has been found that the signal to noise ration can be improved by filtering or suppressing the ultrasonic part of the emitted sound, for example be reducing those frequencies, for example the frequencies of more than 17 kHz, by at least 95 dB, for example 100 dB. This can for example be done by a LAKE filter. Such filtering or suppressing has been found to only minimally affect the emitted sound while at the same time increasing the signal to noise ratio so that the signal can be more easily recognized by the devices.

According to another embodiment of the current invention, the signal to noise ratio can be improved by increasing the intensity with which the signal is transmitted with respect to the intensity of the noise.

According to further preferred embodiments of the current invention, the signal to noise ratio is improved by filtering or suppressing the ultrasonic part of the emitted sound and by increasing the intensity with which the signal is transmitted such as to combine the two embodiments. It has been found in such embodiments that since the intensity with which the signal is transmitted can be lowered the quality of the signal can be improved, as it has been found that the quality of the signal decreases at higher levels of intensity, especially as ultrasonic signals are being transmitted.

According to preferred embodiments of the current invention, the loudspeakers used to transmit the signal are ribbon speakers and/or planar magnetic speakers, as it has been found that such loudspeakers allow the production of ultrasonic signals at relative high levels of intensity, such as for example 95 dB, but preferably 92 dB, measured at a distance of 1 m from the speaker per speaker, especially when taking into account that it is desired to create substantially pure sines.

According to preferred embodiments of the current invention, the devices are humanly portable devices, preferably mobile phones, more preferably smart mobile phones, also called smart phones, as the now wide-spread use of such devices by people in general allows using the already available devices of the people attending an event for creating the desired human perceivable output at the event. However, other humanly portable devices are also possible such as for example jewellery, such as ear-rings, bracelets, rings, tiaras, etc., clothing, such as for example hats, such as for example caps, etc., pants, shirts, shoes, scarfs, (bow)ties, etc., tablets, such as more in particular tablet computers, etc., key hangers, toys, light emitting device, for example purposely built human portable devices specifically built for an event, etc. Although the device can be a single unit, the device may also comprise different units which may communicate with each other wired and/or wirelessly using known protocols and/or technologies such as WiFi, Bluetooth, infrared, etc. This way a receiver unit can be provided, which is provided to receive the acoustic signal and which is provided to be connected, either wired or wirelessly, to peripheral units comprising the display means.

According to other alternative embodiments of the current invention, the devices are not humanly portable, for example: light emitting devices, safety equipment, such as for example first aid equipment, advertising panels, etc.

According to more preferred embodiments of the current invention, the processors are programmed by a software product, for example an applet, running on the device, for example a smart mobile phone, the software product controlling the human perceivable output of the output means of the devices based on the human unperceivable signal received by the input means. Such software products are relatively easy to write, distribute and install and can thus, for example be installed by the user of a phone, for example a smart phone, after having obtained the phone.

According to more preferred embodiments of the current invention, the software product was downloaded to the humanly portable devices, for example mobile phones, before transmitting the human unperceivable signal, preferably before joining the group of people, for example before attending the event and/or the venue. It has been found that such software products allow that the human unperceivable signal directly controls the human perceivable output without requiring additional information retrieved from, for example, a website. It has been found that in such embodiments the devices do not need to retrieve the desired human perceivable output after receipt of the acoustic signal, but can output the desired human perceivable output substantially directly after receipt of the acoustic signal, decreasing the response times significantly and avoiding for example that lots of people suddenly use a WiFi network, clogging the network.

According to more preferred embodiments of the current invention, the event and/or venue attended by the members of the group of people is selected by the members from a list of possible events and/or venues to attend presented to the members by the software product installed on, for example, the mobile phones and wherein selection of the event and/or venue programs the processor such that, in response to reception of the human unperceivable signal, the processors send the second electronic signals corresponding to the selected event and/or venue to the output means for correspondingly controlling the human perceivable output of the output means of the devices according to the event and/or venue selected. In such case a single software product can be sufficient to allow controlling the output of the devices at different events and/or at different venues, such that no different software products need to be installed on, for example, the mobile phone. Moreover, when the selection of the event and/or venue by the respective users of the software product is signaled to an information gathering server such that attendance of the event and/or venue by the respective users of the software product can be recorded, such method allows monitoring who precisely attends the events and/or venues, especially when the recorded attendance of the event and/or venue by at least part of the respective users of the software product is shown on and/or connected to a social media site. For example, through push notification functionality updates and content are pushed to the users of the software product.

According to preferred embodiments of the current invention, the human perceivable output is any one or more of: sound, light, vibration, etc. and the respective output means is any or more of: a speaker, a screen, a vibrator, etc. Specific examples are for example text, movies, pictures, etc. In addition, for example, also credits can be transmitted as human perceivable output. The credit can for example be in the form of the number and/or nature of human unperceivable output received by the member of the group of people. This way, it becomes possible to transmit a credit to the members of the group of people, for example, every time a certain event takes place, for example when during a sport event a goal is scored by one of the teams, for example, the team or which the respective members of the group of people are supporting. These credits can for example reflect the score of the game or could for example have a financial value which can be exchanged for, for example, goods or services at the venue, for example, a drink, a snack, etc.

According to preferred embodiments of the invention, the devices are programmed, preferably by providing the devices with the desired human perceivable output, before receipt of the acoustic signal such that the desired human perceivable output of the device is outputted by the device upon receipt of the acoustic signal. It has been found that in such embodiments the devices do not need to retrieve the desired human perceivable output after receipt of the acoustic signal, but can output the desired human perceivable output substantially directly after receipt of the acoustic signal, decreasing the response times significantly and avoiding for example that lots of people suddenly use a WiFi network, clogging the network.

According to preferred embodiments of the invention, the intensity of the acoustic signal is substantially higher than the intensity of other sounds, representing noise, at least at the frequencies at which the acoustic signal is transmitted. The noise, in case of a music event, for example, comprises the music emitted to the audience and the sounds generated by the audience.

The acoustic signal can be in the form of any one or more of a pulse, for example at a certain frequency or a combination of different frequencies, a series of pulses, can be encoded with phase-shift keying (PSK), amplitude-shift keying (ASK), frequency-shift keying (FSK), etc. According to preferred embodiments of the current invention, phase-shift keying allows encoding information without having to change frequency and intensity which is desired in applications where the frequencies and/or intensities available for transmitting the acoustic signal are limited. This is for example the case when using known audio equipment, such as for example known speakers, amplifiers, mixing consoles, etc., in for example music events, which are often limited, for example in frequency range and/or in intensity, etc., in their capabilities for transmission of human unperceivable acoustic signals, especially ultrasonic signals. For example, known audio equipment for use at music events is often only provided to operate up to and including a frequency of about 20 kHz, limiting transmission of ultrasonic acoustic signals through the audio equipment, to the 17 kHz-20 kHz range. Moreover, when nevertheless using such audio equipment in the 17 kHz-20 kHz range, the intensity of sound with such frequencies is often limited. It has been found that in such situations a frequency for the acoustic signal of about 18 kHz preferably is used, as it has been found that such signal is transmitted relatively well by known transmitters.

According to preferred embodiments of the current invention, the processor improves the signal to noise ratio, for example through a receiver operating characteristic (ROC) methodology, in the first signal as this reduces the risk that although a signal has been transmitted to the devices, no signal is detected by the device as it remains hidden in the noise which is also recorded by the microphone.

According to more preferred embodiments of the current invention, the devices comprise memories storing previously generated first signals and wherein the previously generated first signals are subtracted from subsequent first signals. Such relatively straightforward way of improving the signal to noise ratio has been found to substantially decrease the noise in relation to the signal in the sound recorded by the microphone by subtracting sound previously recorded by the microphone. Moreover, it has been found that noise often is depended on the location where the acoustic signal needs to be detected and that such method takes into account the noise at the location of the actual desired receipt of the acoustic signal.

According to preferred embodiments of the current invention, Phase-Locked Loop (PLL) techniques are used by the processors of the devices. It has been found that such techniques allow, especially when PSK has been used, are a reliable technique for detection of possible signals in the sound detected by the microphones of the devices. Moreover, it has been found that such techniques allow a fast response of the devices after receipt of the acoustic signal, reducing the delay in between transmittal of the acoustic signal and output of the human perceivable output by the devices, which is preferred when the human perceivable output of the output means of the devices must be substantially synchronized and/or substantially simultaneous with emitted sound, for example when the human perceivable output of the devices outputted by the devices must be outputted on the rhythm of music which is also transmitted.

According to preferred embodiments of the current invention, the processor of the devices only considers sound detected by the microphone having a predetermined minimal intensity as possibly containing an acoustic signal. Thereto, for example, from the sound recorded by the microphone a predetermined intensity is subtracted by the processor, after which the resulting sound is being further evaluated by the processor for detection of one or more acoustic signals.

According to preferred embodiments of the current invention, the devices are carried by members of a group of people, such as for example an audience of an event and/or an audience at an event, for example an event at a venue although this is not critical for the invention such as for example a group of people at a venue, for example a group of people at a themepark or other locations, and the human perceivable output of the plurality of devices is controlled such that a predetermined coordinated output, for example a coordinated audience assisted output, is generated by the devices.

According to preferred embodiments of the current invention, the audience assisted output is any one or more of: an audience assisted image, an audience assisted sound, an audience assisted movie, etc.

According to preferred embodiments of the current invention, the event is one or more of: a funeral, a fair, a demonstration, a congress, an entertainment event, such as for example any one or more of: a music event, such as for example a concert, such as for example a rock concert, a classical concert, a folk concert, a techno concert, etc., a party, etc., a sporting event, for example a soccer game, a car race, a tennis match, a golf tournament, a football match, a baseball match, a basketball match, a cricket mach, a cycling event, etc., a theatre performance, a movie projection, a party, etc., a teaching event, for example a lecture, etc. Often at such events such audience assisted output may be desired.

When the group of people are gathered at a venue, for example during an event at the venue, often the transmitters needed to transmit the acoustic signal according to the invention are already available at the venue in the form of the audio equipment present at the venue for generating sound, for example for addressing the public known as a public address system, which is often able to transmit the acoustic signal according to the invention. In such case, the group of people, for example during an event, is gathered at a venue and the human unperceivable signal is transmitted through at least one of speakers provided at the venue. The event for example is a music event and the human unperceivable signal is transmitted through at least one of the speakers provided at the music event.

According to preferred embodiments of the current invention, the members of the audience are subdivided into at least two groups and the human perceivable output of the output means of the devices is controlled in function of the group to which the respective devices of the members belong to, for example male/female, whether they are supporter of a certain sports club, such as for example a certain football club, specifically if they are attending a match between two sports clubs, whether they support the one or the other club, etc. Such embodiments allow that the human perceivable output of the devices is controlled in function of the group to which the members of the audience belong, which can be desired depending on the event the members of the audience are attending. The group to which the members of the audience belong can for example be inputted in the devices by the members.

According to preferred embodiments of the current invention, preferably based on the human unperceivable signal, the processor determines a location of the device with respect to at least one transmitter of the human unperceivable signal and controls the human perceivable output of the output means of the devices in function of the determined location. Such embodiments for example allow that the human perceivable output of the output means of the devices in function of the determined location is any one or more of: a composite image, for example a flag, for example a national flag, a commercial logo, a picture, a text, etc. and/or movie composed of the human perceivable output of the output means of the respective devices, a composite sound and/or music composed of the human perceivable output of the output means of the respective devices, etc. Although according to preferred embodiments of the current invention, the location can be determined based on the human unperceivable signal itself, as will be described later, the location can also be determined based on, for example, input of the human carrier of the device, for example, by inputting a location, for example a seat or standing number, or more approximately a section of the venue, etc.

According to more preferred embodiments of the current invention, the human perceivable output of the output means of the devices in function of the determined location comprises a composite sound and/or music composed of the human perceivable output of the output means of the respective devices with the human perceivable output of the output means of respective devices or group of devices representing any one or more of: an instrument or group of instruments, an audio channel of at least two audio channels, etc.

According to more preferred embodiments of the current invention, at least two, such as for example two, three, four, etc., transmitters of the human unperceivable signal are provided and the location is determined by triangulation and/or trilateration, preferably trilateration, as such method of determining the location of, for example, the members of an audience can be relative straightforward performed, for example using the often already provided audio equipment. As often, for example at music events, stereophonic sound, or sound employing even more sound channels, is used at venues and/or events, the different sound channels can for example be used for trilateration and/or triangulation, preferably trilateration.

According to preferred embodiments of the current invention, at least two human unperceivable signals are transmitted, the respective signals differently controlling the human perceivable output of the output means of the devices. According to more preferred embodiments of the present invention, for the respective human unperceivable signals the human perceivable output of the output means of the devices differs. Such signals for example allow that for example different colors are shown on the screens of the devices depending on the respective human unperceivable acoustic signal which has been transmitted to the devices, the different human unperceivable acoustic signals representing different colors to be shown on the screens of the devices. Moreover or alternatively, the human perceivable output of the output means of the devices may further differ when using combinations of two or more of the respective signals.

According to more preferred embodiments of the current invention, the human unperceivable signals differ in any one or more of: intensity, frequency, phase, pulse, etc.

According to more preferred embodiments of the current invention, the human unperceivable acoustic signals differ in frequency, for example at least one of the multiple frequencies forming the signal differs, as it has been found that such acoustic frequencies can be relatively easy distinguished from each other by the devices. To improve distinguishing the signals from each other further, it has been found that the frequency or even frequencies of the sound making up the human unperceivable signals differ from each other with at least 50 Hz, 250 Hz, or even at least 500 Hz. Therefore within the preferred range of 17 kHz-20 kHz, preferably maximally about 7 frequencies can be provided, when allowing for a variation of about 250 Hz more or less than the frequency value and keeping at least 500 Hz in between two frequencies used, for example respective frequencies at about 17 kHz, about 17.5 kHz, about 18 kHz, about 18.5 kHz, about 19 kHz, about 19.5 kHz, about 20 kHz, more preferably maximally about 7. Naturally by employing PSK, increasing the difference in frequencies, etc. distinguishing between signals can be further improved. For example PSK allows reducing the difference in frequency between the frequencies, for example to 250 Hz or even less. The frequencies and the difference between them can be determined depending on the desired configuration, for example the desired number of signals for a certain application and for example can be determined such as to for example maximize the difference between the different frequencies representing for example respective signals or a single signal such as to improve distinguishing between different signals.

For example, different frequencies can be chosen with frequencies at about 17383 Hz, 17482 Hz, 17582 Hz, 17683 Hz, 17785 Hz, 17889 Hz and 17993 Hz, i.e. spanning a range of about 610 Hz with less than 100 Hz in between the different signals. A chip having the possibility to provide such signals, even parallelly for transmitting signals comprising for example 7 frequencies, is for example the chip PROPELLOR marketed by the firm PARALLAX.

It has moreover been found that such frequencies, the signal for example having a single frequency and for example being a substantially pure sine or the signal being composed of different frequencies, for example all being substantially pure sines, have a maximal variation of about 250 Hz, more preferably 100 Hz or most preferably even 50 Hz especially when the different signals differ only with about 500 Hz or even less. Preferably, the Total Harmonic Distortion (THD) is below 0.5%, more preferably below 0.3%, for example about 0.27%, most preferably below 0.1%. It has been found that such a precision is sufficient for detecting the signal with the devices and allows to sufficiently decrease the calculation time of the devices increasing the responsiveness of the human perceivable output as, for example, when the frequency of different acoustic signals are relatively close with respect to each other, it will be more complex for the processor to distinguish the different signals from each other, leading to a longer calculation time for the processor of the devices.

Preferably, when switching between different unperceivable signals having for example different frequencies, a windowing technique such as a Hamming method is applied to avoid human hearable undesired artifacts.

According to preferred embodiments of the current invention, the signal is composed of different frequencies being transmitted substantially simultaneously, preferably by substantially pure sinuses, and thus forming a binary code wherein for example a one bit represents the presence or absence, usually the presence, of a certain frequency and a zero bit correspondingly represents the presence or absence, usually the absence, of the frequency. Different binary codes in such case represent different signals, possibly relating to different human perceivable output of the devices.

According to further preferred embodiments of the current invention, the code is a Hamming-code in which a first part of the code represents information and a second part, usually the remaining bits, represents a check of the correctness of the first part. Such code usually is represented as Hamming (number of bits in the first part and the second part, number of bits in the second part) such that for example Hamming (7, 3) means that seven bits are present in the code of which the last three, usually called parity bits, represent the check of the correctness of the first four.

It has been found that a signal with Hamming (7, 3) offers good results. It is envisaged that also Hamming (15, 4) or even Hamming (32, 5) will also offer good results and allow more information to be transmitted. In case a Hamming (32, 5) is used, it has been found that the maximal variation of the sinuses used is 50 Hz.

Preferably, a first human unperceivable signal is usually transmitted, except when human perceivable output is desired and the first human unperceivable signal is replaced by a second human unperceivable signal triggering the devices to output the human perceivable output. It has been found that such technique allows to decrease the risk that signals are unwantedly being picked up or ignored by the devices.

Preferably, the devices are programmed such that sound is filtered between the frequencies to further enhance the signal to noise ratio. For example, sound having a frequency larger or smaller than 5 Hz, preferably 3 Hz, than the expected frequencies is filtered out.

Preferably, the devices are programmed such that Schmitt-triggers determine whether a certain detected frequency is part of the signal or not.

It has been found that devices being programmed to a sampling frequency of 48000 Hz allow a good interpretation of the transmitted human unperceivable signal by the devices.

It has been found that in such embodiment, the audio signal is transmitted, preferably continuously, in blocks of about 0.05 seconds, i.e. each block representing about 2400 audio samples.

According to preferred embodiments of the current invention, the human perceivable output comprises a timed sequence of output events, the output events being any one or more of: sound, light, vibration, etc. The timed sequence of output events is for example any one or more of: music, movies, vibrations, etc.

The invention also relates to a system for performing the method according to the invention.

According to preferred embodiments of the system according to the current invention, the system comprises a transmitter and a plurality of devices, the devices comprising input means for receiving signals and transforming them to electric signals, the input means comprising at least a microphone, a processor for receiving the electric signals and output means for outputting human perceivable output in response to electric signals from the processor, the transmitter being provided to transmit a human unperceivable signal, the input means of the devices being provided to receive the signal, transforming it to corresponding first electric signals and sending the corresponding first electronic signals to the processors of the devices, the processors being programmed such that, in response, the processors send second electronic signals to the output means for correspondingly controlling the human perceivable output of the output means of the devices. The human unperceivable signal is a human unperceivable acoustic signal. The microphones of the input means of the devices are provided to receive the human unperceivable sound and to transform the human unperceivable sound to electric signals received by the processor.

According to preferred embodiments of the system according to the present invention, the human unperceivable acoustic signal is an ultrasonic signal.

According to preferred embodiments of the system according to the present invention, the devices are humanly portable devices, preferably mobile phones or tablets, preferably smart mobile phones.

According to preferred embodiments of the system according to the present invention, the processors are programmed by a software product installed on the devices, the software product being provided for controlling the human perceivable output of the output means of the devices based on the human unperceivable signal received by the input means.

According to preferred embodiments of the invention, the devices are programmed, preferably by providing the devices with the desired human perceivable output, before receipt of the acoustic signal such that the desired human perceivable output of the device is outputted by the device upon receipt of the acoustic signal. It has been found that in such embodiments the devices do not need to retrieve the desired human perceivable output after receipt of the acoustic signal, but can output the desired human perceivable output substantially directly after receipt of the acoustic signal, decreasing the response times significantly and avoiding for example that lots of people suddenly use a WiFi network, clogging the network.

According to preferred embodiments of the system according to the present invention, the human perceivable output is any one or more of: sound, light, vibration, etc. and the respective output means is any or more of: a speaker, a screen, a vibrator, etc.

According to preferred embodiments of the invention, the transmitter is provided such that the intensity of the acoustic signal is substantially higher than the intensity of other sounds, representing noise, at least at the frequencies at which the acoustic signal is transmitted. The noise, in case of a music event, for example, comprises the music emitted to the audience and the sounds generated by the audience.

The transmitter preferably is provided such that the acoustic signal is in the form of any one or more of a pulse, for example at a certain frequency, a series of pulses, can be encoded with phase-shift keying (PSK), amplitude-shift keying (ASK), frequency-shift keying (FSK), etc. Preferably phase-shift keying is employed as such technique allows encoding information without having to change frequency and intensity which is desired in applications where the frequencies and/or intensities available for transmitting the acoustic signal are limited. This is for example the case when using known audio equipment, such as for example speakers, amplifiers, mixing consoles, etc. of an already present public address system, in for example music events, which are often limited, for example in frequency range and/or in intensity, etc., in their capabilities for transmission of human unperceivable acoustic signals, especially ultrasonic signals. For example, known audio equipment for use at music events is often only provided to operate up to and including a frequency of about 20 kHz, limiting transmission of ultrasonic acoustic signals through the audio equipment, to the 17 kHz-20 kHz range. Moreover, when nevertheless using such audio equipment in the 17 kHz-20 kHz range, the intensity of sound with such frequencies is often limited. It has been found that in such situations a frequency for the acoustic signal of about 18 kHz preferably is used, as it has been found that such signal is transmitted relatively well by known transmitters.

It has been found that the signal to noise ration can be improved by filtering or suppressing the ultrasonic part of the emitted sound, for example be reducing those frequencies, for example the frequencies of more than 17 kHz, by at least 95 dB, for example 100 dB. This can for example be done by a LAKE filter. Such filtering or suppressing has been found to only minimally affect the emitted sound while at the same time increasing the signal to noise ratio so that the signal can be more easily recognized by the devices.

As an alternative or even in addition a sound system separate from the public address system can be added specifically for transmitting the ultrasonic acoustic signal.

According to preferred embodiments of the current invention, the processor is provided to improve the signal to noise ratio in the first signal, for example through a receiver operating characteristic (ROC) methodology, as this reduces the risk that although a signal has been transmitted to the devices, no signal is detected by the device as it remains hidden in the noise which is also recorded by the microphone.

According to more preferred embodiments of the current invention, the devices comprise memories provided to store previously generated first signals and wherein the processor is provided to subtract previously generated first signals from subsequent first signals. Such relatively straightforward way of improving the signal to noise ratio has been found to substantially decrease the noise in the sound recorded by the microphone in relation to the signal by subtracting sound previously recorded by the microphone. Moreover, it has been found that noise often is depended on the location where the acoustic signal needs to be detected and that such method takes into account the noise at the location of the actual desired receipt of the acoustic signal.

According to preferred embodiments of the current invention, the processors are provided to use Phase-Locked Loop (PLL) techniques. It has been found that such techniques allow, especially when PSK has been used, a reliable technique for detection of possible signals in the sound detected by the microphones of the devices. Moreover, it has been found that such techniques allow a fast response of the devices after receipt of the acoustic signal, reducing the delay in between transmittal of the acoustic signal and output of the human perceivable output by the devices, which is preferred when the human perceivable output of the output means of the devices must be substantially synchronized and/or substantially simultaneous with emitted sound, for example when the human perceivable output of the devices outputted by the devices must be outputted on the rhythm of music which is also transmitted.

According to preferred embodiments of the current invention, the processor of the devices are provided to only consider sound detected by the microphone having a predetermined minimal intensity as possibly containing an acoustic signal. Thereto, for example, the processors are provided to subtract from the sound recorded by the microphone a predetermined intensity, after which the resulting sound is being further evaluated by the processor for detection of one or more acoustic signals.

According to preferred embodiments of the system according to the present invention, the processor is provided to improve the signal to noise ratio in the first signal.

According to more preferred embodiments of the system according to the present invention, the devices comprise memories for storing previously generated first signals and wherein the processors are programmed such that the previously generated first signals are subtracted from subsequent first signals.

According to preferred embodiments of the system according to the present invention, the devices are carried by members of a group of people. The human perceivable output of the plurality of devices is provided to be controlled such that a predetermined coordinated output, for example coordinated audience assisted output, is generated by the devices.

According to more preferred embodiments of the system according to the present invention, the audience assisted output is any one or more of: an audience assisted image, an audience assisted sound, an audio assisted movie, etc.

According to more preferred embodiments of the system according to the present invention, the group of people is an audience of an event and/or an audience at a venue and the event is one or more of: a funeral, a fair, a demonstration, a congress, an entertainment event, such as for example any one or more of: a music event, such as for example a concert, such as for example a rock concert, a classical concert, a folk concert, etc., a party, etc., a sporting event, for example a soccer game, a basketball match, a car race, a tennis match, a golf tournament, a football match, a baseball match, a cricket mach, a cycling event, etc., a theatre performance, a movie projection, a party, etc., a teaching event, for example a lecture, etc.

According to more preferred embodiments of the system according to the present invention, the group of people is gathered at a venue and the human unperceivable signal is provided to be transmitted through at least one of the speakers provided at the music event.

According to preferred embodiments of the system according to the present invention, the software product has been installed on the humanly portable devices, such as for example mobile phones or tablets, before transmitting the human unperceivable signal, preferably before attending the event and/or the venue.

According to preferred embodiments of the system according to the present invention, the event and/or venue attended by the members of the group of people can be selected by the members from a list of possible events and/or venues to attend provided to be presented to the members by the software product installed on the mobile phones and wherein selection of the event and/or the venue programs the processor such that, in response to reception of the human unperceivable signal, the processors send the second electronic signals corresponding to the selected event and/or venue to the output means for correspondingly controlling the human perceivable output of the output means of the devices according to the event and/or venue selected.

According to preferred embodiments of the system according to the present invention, the selection of the event and/or venue by the respective users of the software product is provided to be signaled to an information gathering server such that attendance of the event and/or venue by the respective users of the software product can be recorded. For example, through push notification functionality updates and content are pushed to the users of the software product.

According to preferred embodiments of the system according to the present invention, the recorded attendance of the event and/or the venue by at least part of the respective users of the software product is provided to be shown on a social media site.

According to preferred embodiments of the current invention, the system is provided to divide the members of the audience into at least two groups and is provided to control the human perceivable output of the output means of the devices in function of the group to which the respective devices of the members belong to, for example male/female, whether they are supporter of a certain sports club, such as for example a certain football club, specifically if they are attending a match between two sports clubs, whether they support the one or the other club, etc. Such embodiments allow that the human perceivable output of the devices is controlled in function of the group to which the members of the audience belong, which can be desired depending on the event the members of the audience are attending.

According to preferred embodiments of the system according to the present invention, based on the human unperceivable signal, the processor is provided to determine a location of the device with respect to at least one transmitter of the human unperceivable signal and is provided to control the human perceivable output of the output means of the devices in function of the determined location.

Although according to preferred embodiments of the current invention, the location can be determined based on the human unperceivable signal itself, the location can also be determined based on, for example, input of the human carrier of the device, for example, by inputting a location, for example a seat or standing number, or more approximately a section of the venue, etc.

According to preferred embodiments of the system according to the present invention, the system comprises at least two transmitters of the human unperceivable signal and the location determination is provided to be done by triangulation and/or trilateration, preferably trilateration.

According to preferred embodiments of the system according to the present invention, the human perceivable output of the output means of the devices in function of the determined location is any one or more of: a composite image and/or movie composed of the human perceivable output of the output means of the respective devices, a composite sound and/or music composed of the human perceivable output of the output means of the respective devices, etc.

According to preferred embodiments of the system according to the present invention, the human perceivable output of the output means of the devices in function of the determined location comprises a composite sound and/or music composed of the human perceivable output of the output means of the respective devices with the human perceivable output of the output means of respective devices or group of devices representing any one or more of: an instrument or group of instruments, an audio channel of at least two audio channels, etc.

According to preferred embodiments of the system according to the present invention, the transmitters are provided to transmit at least two human unperceivable signals, the respective signals and/or combinations of the signals being provided to differently control the human perceivable output of the output means of the devices.

According to preferred embodiments of the system according to the present invention, the human unperceivable signals differ in any one or more of: intensity, frequency, phase, etc.

According to preferred embodiments of the system according to the present invention, for the respective human unperceivable signals and/or combinations of the signals the human perceivable output of the output means of the devices differs.

According to preferred embodiments of the system according to the present invention, the human perceivable output comprises a timed sequence of output events, the output events being any one or more of: sound, light, vibration, etc.

According to preferred embodiments of the system according to the present invention, the timed sequence of output events is any one or more of: music, movies, vibrations, etc.

The invention also relates to a transmitter provided to perform the method according to the invention and thereto comprises a source provided to generate the human unperceivable acoustic signal, an amplifier for amplifying the human unperceivable acoustic signal connected to the source and at least one speaker for transmitting the amplified human unperceivable acoustic signal to the devices.

The invention also relates to a device programmed to perform the method according to the invention.

According to preferred embodiments of the device according to the invention, the device is a humanly portable device, preferably a mobile phone, more preferably a smart mobile phone. The processor of the device can be programmed by a software product installed on the device, although this is not critical for the invention as it also can be provided with the necessary functionality by substantially an electronic circuitry instead of the software product, the software product being provided to control the human perceivable output of the output means of the device based on the human unperceivable signal received by the input means.

The invention also relates to a software product for performing the method according to the invention.

According to preferred embodiments of the software product according to the present invention, the processor of a humanly portable device can be programmed by the software product after installation of the software product on the humanly portable device, such that the software product is provided to control the human perceivable output of the output means of the devices based on the human unperceivable signal received by the input means.

The invention also relates to a human unperceivable acoustic signal for performing the method according to the invention.

According to preferred embodiments of the human unperceivable acoustic signal according to the invention, the human unperceivable acoustic signal is an ultrasonic signal.

According to more preferred embodiments of the human unperceivable acoustic signal according to the invention, the ultrasonic acoustic signal comprises a frequency of more than 17 kHz, preferably between 17 kHz and 25 kHz, more preferably between 17 kHz and 20 kHz, most preferably 18 kHz.

According to more preferred embodiments of the current invention, the human unperceivable acoustic signals differ in frequency, for example at least one of the multiple frequencies forming the signal differs, as it has been found that such acoustic frequencies can be relatively easy distinguished from each other by the devices.

According to more preferred embodiments of the human unperceivable acoustic signal according to the invention, the frequency of the human unperceivable acoustic signal has a maximal variation of about 250 Hz, more preferably 100 Hz especially when the different signals differ only with about 500 Hz or even less.

To improve distinguishing the signals from each other further, it has been found that the frequency or even frequencies of the sound making up the human unperceivable signals differ from each other with for example at least 50 Hz, 250 Hz, or even at least 500 Hz. Therefore within the preferred range of 17 kHz-20 kHz, preferably maximally about 7 frequencies can be provided, when allowing for a variation of about 250 Hz more or less than the frequency value and keeping at least 500 Hz in between two frequencies used, for example respective frequencies at about 17 kHz, about 17.5 kHz, about 18 kHz, about 18.5 kHz, about 19 kHz, about 19.5 kHz, about 20 kHz, more preferably maximally about 7. Naturally by employing PSK, increasing the difference in frequencies, etc. distinguishing between signals can be further improved. For example PSK allows reducing the difference in frequency between the frequencies, for example to 250 Hz or even less. The frequencies and the difference between them can be determined depending on the desired configuration, for example the desired number of signals for a certain application and for example can be determined such as to for example maximize the difference between the different frequencies representing for example respective signals or a single signal such as to improve distinguishing between different signals.

For example, different frequencies can be chosen with frequencies at about 17383 Hz, 17482 Hz, 17582 Hz, 17683 Hz, 17785 Hz, 17889 Hz and 17993 Hz, i.e. spanning a range of about 610 Hz with less than 100 Hz in between the different signals.

It has moreover been found that such frequencies, the signal for example having a single frequency and for example being a substantially pure sine or the signal being composed of different frequencies, all being for example substantially pure sines, have a maximal variation of about 250 Hz, more preferably about 100 Hz or even about 50 Hz especially when the different signals for example differ only with about 500 Hz or even less. Preferably, the Total Harmonic Distortion (THD) is below 0.5%, more preferably below 0.3%, for example about 0.27%, most preferably less than 0.1%. It has been found that such a precision is sufficient for detecting the signal with the devices and allows to sufficiently decrease the calculation time of the devices increasing the responsiveness of the human perceivable output as, for example, when the frequency of different acoustic signals are relatively close with respect to each other, it will be more complex for the processor to distinguish the different signals from each other, leading to a longer calculation time for the processor of the devices.

According to preferred embodiments of the current invention, any one or more of the following frequencies are used in the signal as these signals have been found to be surprisingly well detectable by the devices, especially by mobile smart phones and especially when being employed during a concert: 17383 Hz, 17482 Hz, 17582 Hz, 17683 Hz, 17785 Hz, 17889 Hz and 17993 Hz.

According to preferred embodiments of the current invention, the signal is composed of different frequencies being transmitted substantially simultaneously and thus forming a binary code wherein for example a one bit represents the presence or absence, usually the presence, of a certain frequency and a zero bit correspondingly represents the presence or absence, usually the absence, of the frequency. Different binary codes in such case represent different signals, possibly relating to different human perceivable output of the devices.

According to further preferred embodiments of the current invention, the code is a Hamming-code in which a first part of the code represents information and a second part, usually the remaining bits, represents a check of the correctness of the first part. Such code usually is represented as Hamming (number of bits in the first part and the second part, number of bits in the second part) such that for example Hamming (7, 3) means that seven bits are present in the code of which the last three, usually called parity bits, represent the check of the correctness of the first four.

It has been found that a signal with Hamming (7, 3) offers good results. It is envisaged that also Hamming (15, 4) or even Hamming (32, 5) will also offer good results and allow more information to be transmitted.

According to preferred embodiments of the current invention, the audio signal is transmitted in blocks of about 0.05 seconds.

The invention will be further elucidated by means of the following description and the appended figures.

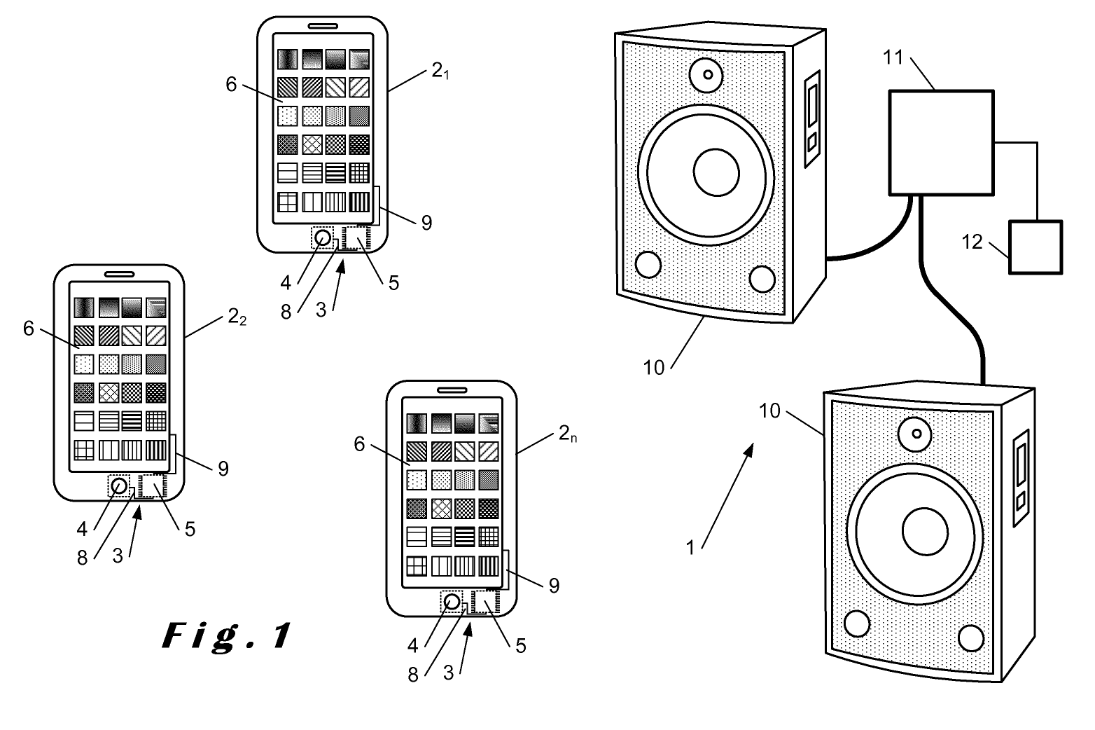

FIG. 1 shows a schematic overview of the system according to the current invention.

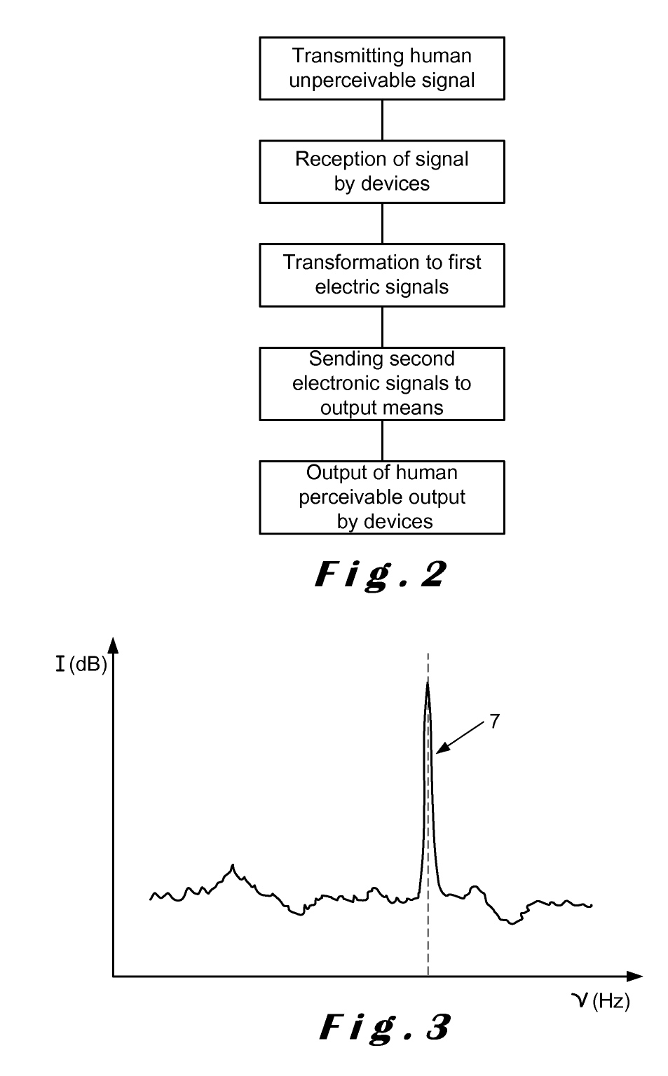

FIG. 2 shows a schematic overview of the method according to the current invention.

FIG. 3 shows a schematic overview of acoustic information received by a device according to the present invention comprising an acoustic signal according to the present invention.

In the following detailed description, numerous specific details are set forth in order to provide a thorough understanding of the invention and how it may be practiced in particular embodiments. However, it will be understood that the present invention may be practiced without these specific details. In other instances, well-known methods, procedures and techniques have not been described in detail, so as not to obscure the present invention. While the present invention will be described with respect to particular embodiments and with reference to certain drawings, the invention is not limited hereto. The drawings included and described herein are schematic and are not limiting the scope of the invention. It is also noted that in the drawings, the size of some elements may be exaggerated and, therefore, not drawn to scale for illustrative purposes.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B.

FIG. 1 shows a schematic overview of the system according to the current invention.

The system comprises a transmitter 1 and a plurality of devices 2. The devices 2 comprise input means 3 for receiving signals and transforming them to electric signals 8, 9. The input means 3 comprise at least a microphone 4, a processor 5 for receiving the electric signals 8 and output means 6 for outputting human perceivable output in response to electric signals 9 from the processor 5. The transmitter 1 is provided to transmit a human unperceivable signal. The input means 3 of the devices 2 are provided to receive the signal, transform it to corresponding first electric signals 8 and send the corresponding first electronic signals 8 to the processors 5 of the devices. The processors 5 are programmed such that, in response, the processors 5 send second electronic signals 9 to the output means 6 for correspondingly controlling the human perceivable output of the output means 6 of the devices 2. The human unperceivable signal is a human unperceivable acoustic signal 7 and the microphones 4 of the input means 3 of the devices 2 are provided to receive the human unperceivable acoustic signal 7 and to transform the human unperceivable acoustic signal 7 to electric signals received by the processor 5.

The transmitter 1 shown in the FIG. 1 is audio equipment present at a venue for generating sound. The event at which the audio equipment is for example used for example is a music event and the human unperceivable signal is transmitted through at least one of the speakers 10 provided at the music event. The audio equipment further for example comprises an amplifier 11 connected to, for example, a source for the human unperceivable signal, for example, an ultrasonic signal generator 12. Naturally other configurations are possible. Although not shown in FIG. 1, next to the ultrasonic generator 12, other sound generating sources can be connected to the amplifier 11, for example instruments or sound reproducing devices for reproducing recorded sounds on for example CD, tape, LP, etc. so that the acoustic signal can be transmitted together with the music at a music event.

The devices 2 shown in FIG. 1 are in the form of smart mobile phones 2 which are shown only schematically. The output means 6 shown in FIG. 1 are the screens of the mobile phones 2.

FIG. 2 shows a schematic overview of the method according to the current invention.

The method comprises the steps of transmitting a human unperceivable signal. Subsequently, the input means 3 of the devices 2 receive the signal, transform it to corresponding first electric signals 8 and send the corresponding first electronic signals 8 to the processors 5 of the devices, as shown in FIG. 2. Further, the processors 5, in response, send second electronic signals 9 to the output means 6 which then correspondingly output the human perceivable output.

The first and the second electric signals 8, 9 can be for example a voltage, a current or a specific sequence of voltages and/or currents or any type of electric signal deemed appropriate by the person skilled in the art.

FIG. 3 shows a schematic overview of acoustic information received by a device according to the present invention comprising an acoustic signal according to the present invention. The acoustic signal in FIG. 3 for example comprises a soundpulse at a certain frequency v in Hz with an intensity I in dB. As can be seen the intensity of the soundpulse is relatively large in comparison to the intensity of the remaining sound recorded by the device, making it possible for the device to detect the soundpulse using known signal processing techniques. The soundpulse shown in FIG. 3 could for example make the devices shown in FIG. 1 display a single colour on their output means 6.

The method according to the present invention was tested at a concert hall having an existing audio installation for generating sound for music events organized at the venue. The speakers used were for example speakers marketed under the name of K1 SPEAKERS, ADAMSONS and LABTEC. An acoustic signal was transmitted using the available audio equipment with an intensity of about 120-140 dB while also transmitting humanly audible music with an overall intensity of about 95-110 dB. The acoustic signal was made of two superimposed soundpulses of respectively 17 kHz and 18 kHz having a maximal variation of about 100 Hz, i.e. 17 kHz±100 Hz and 18 kHz±100 Hz. Other preferred possibilities however are 18 kHz and 19 kHz; 17 kHz and 19 kHz and 17 kHz, 18 kHz and 19 kHz.

Although the acoustic signal, i.e. the soundpulses superimposed on the transmitted music, could not be heard by humans present at the test, the soundpulses could very well be detected using generally available smart mobile phones such as for example APPLE IPHONE 4, APPLE IPHONE 4S, APPPLE IPHONE 3, SAMSUNG GALAXY S III, SAMSUNG GALAXY ACE PLUS S7500 ANDROID, SAMSUNG ANDROID GALAXY ACE 2 I8160, SAMSUNG GALAXY TXT DUOS-GT-B5512 and by tablets such as the APPLE IPAD 1 and the APPLE IPAD 2, even at varying distances of 5, 15 and even 100 meters from the speakers.

1. Method for remotely controlling human perceivable output of a plurality of devices, the devices comprising input means for receiving signals and transforming them to electric signals, the input means comprising at least a microphone, a processor for receiving the electric signals and output means for outputting human perceivable output in response to electric signals from the processor, the method comprising the steps of transmitting a human unperceivable signal, the input means of the devices receiving the signal, transforming it to corresponding first electric signals and sending the corresponding first electronic signals to the processors of the devices, the processors being programmed such that, in response, the processors send second electronic signals to the output means for correspondingly controlling the human perceivable output of the output means of the devices, wherein the human unperceivable signal sent to the devices for remotely controlling the human perceivable output of the devices is a human unperceivable acoustic signal and wherein the microphones of the input means of the devices are provided to receive the human unperceivable acoustic signal and wherein to transform the human unperceivable acoustic signal to the corresponding first electric signals received by the processor.

2. Method according to claim 1, wherein the human unperceivable acoustic signal is an ultrasonic signal.

3. Method according to claim 2, wherein the ultrasonic acoustic signal comprises at least one frequency of more than 17 kHz, preferably between 17 kHz and 25 kHz, more preferably between 17 kHz and 20 kHz, most preferably 18 kHz.

4. Method according to claim 1, wherein the at least one frequency of the human unperceivable acoustic signal has a maximal variation of about 250 Hz, more preferably 100 Hz or even 50 Hz especially when the different signals differ only with about 500 Hz or less.

5. Method according to claim 3, wherein the Total Harmonic Distortion (THD) is below 0.5%, more preferably below 0.3%, for example about 0.27%, most preferably less than 0.1%.

6. Method according to claim 1, wherein the devices are humanly portable devices, more preferably mobile phones, even more preferably smart mobile phones, or tablets.

7. Method according to claim 6, wherein the processors are programmed by a software product, the software product controlling the human perceivable output of the output means of the devices based on the human unperceivable signal received by the input means.

8. Method for remotely controlling human perceivable output according to claim 1, wherein the human perceivable output is any one or more of: sound, light, vibration, etc. and the respective output means is any one or more of: a speaker, a screen, a vibrator, etc.

9. Method according to claim 1, wherein the processor improves the signal to noise ratio in the first signal and wherein the devices comprise memories storing previously generated first signals and wherein the previously generated first signals are subtracted from subsequent first signals.

10. (canceled)

11. Method according to claim 1, wherein the devices are carried by members of a group of people and wherein the human perceivable output of the plurality of devices is controlled such that a predetermined coordinated output, for example a coordinated audience assisted output, is generated by the devices.

12. Method according to claim 11, wherein the audience assisted output is any one or more of: an audience assisted image, an audience assisted sound, an audience assisted movie, etc.

13. Method according to claim 11, wherein the group of people is an audience of an event and/or an audience at a venue and the event is one or more of: a funeral, a fair, a demonstration, a congress, an entertainment event, such as for example any one or more of: a music event, such as for example a concert, such as for example a rock concert, a classical concert, a folk concert, etc., a party, etc., a sporting event, for example a soccer game, a car race, a tennis match, a golf tournament, a football match, a baseball match, a basketball match, a cricket match, a cycling event, etc., a theatre performance, a movie projection, a party, etc., a teaching event, for example a lecture, etc.

14. Method according to claim 1, wherein the devices are carried by a group of people which is gathered at a venue and the human unperceivable signal is transmitted through at least one of speakers provided at the venue.

15. (canceled)

16. (canceled)

17. (canceled)

18. (canceled)

19. Method according to claim 1, wherein based on the human unperceivable signal, the processor determines a location of the device with respect to at least one transmitter of the human unperceivable signal and controls the human perceivable output of the output means of the devices in function of the determined location.

20. (canceled)

21. (canceled)

22. (canceled)

23. (canceled)

24. Method according to claim 1, wherein at least two human unperceivable signals are transmitted, the respective signals and/or combinations of the signals differently controlling the human perceivable output of the output means of the devices.

25. Method according to claim 24, wherein the human unperceivable signals differ in frequency.

26. (canceled)

27. Method according to claim 25, wherein the human unperceivable signals differ from each other with at least 100 Hz, 250 Hz, preferably even 500 Hz.

28. Method according to claim 24, wherein for the respective human unperceivable signals and/or combinations of the respective human unperceivable signals the human perceivable output of the output means of the devices differs.

29. Method according to claim 1, wherein the human perceivable output comprises a timed sequence of output events, the output events being any one or more of: sound, light, vibration, etc.

30-66. (canceled)

67. Method according to claim 7, wherein the software product was downloaded to the humanly portable devices, such as for example mobile phones, before transmitting the human unperceivable signal, preferably before joining the group of people, for example before attending the event and/or the venue.
